(19) United States
(12) Patent Application Publication
(10) Pub. No.: US 2011/0263230 A1
(43) Pub. Date: Oct. 27, 2011

(54) Provision Of An Internet Access For An External Reproduction Device

(76) Inventors: Sascha Meyer, Dortmund (DE); Daniel Schubert, Dusseldorf (DE); Peter Weingart, Bochum (DE); Matthieu Bacquias, Dusseldorf (DE)

(21) Appl. No.: 13/018,028

(22) Filed: Jan. 31, 2011

(30) Foreign Application Priority Data
Jan. 29, 2010 (DE) 10 2010 006 389.4

(51) Int. Cl. H04W 4/00

(52) U.S. Cl. 455/414.1

(57) ABSTRACT

A device for providing an internet access for at least one external reproduction device and for processing data received via the internet and/or have to be sent via the internet, wherein the processed data are at least partially provided as output signal at least at one interface of the device for the use by the at least one reproduction device. The device includes means for sending and/or receiving electronic data via a mobile network and means for the electronic processing of data, including at least one interface for connecting at least one input device.

### CROSS-REFERENCE TO RELATED APPLICATIONS

The present application claims priority of German Patent Application No. 10 2010 006 389.4 filed on Jan. 29, 2010, the content of which is incorporated herein by reference.

### FIELD OF THE INVENTION

The present invention relates to a device and a method for providing an internet access for at least one external reproduction device, preferably a television set, and for processing data which have been received via the internet and/or have to be sent via the internet, wherein the processed data are at least partially provided as output signal, in particular as video and/or audio signal at least at one interface of the device for the use by means of the at least one reproduction device.

### BACKGROUND OF THE INVENTION

The internet with the manifold utilization possibilities thereof, such as the access to information in the World Wide Web, or the use of communication services, such as e-mail or instant messaging, gains in more and more significance and is already a fixed part of daily life in many places. Herein, the user has different possibilities to access internet contents, wherein in particular two substantial possibilities can be distinguished, namely the essentially wire dependent access, on the one hand, and the essentially wireless access, on the other hand. Regarding the essentially wire dependent access to the internet, the internet connection is usually built up via a connecting line between a modem and a dial-in node, wherein the modem is usually connected to a computer, such as a personal computer (PC) or a notebook. Herein, the transmission can also be realized in a wireless manner over shorter distances, for instance by means of WLAN (WLAN: Wireless LAN, LAN: Local Area Network) or Bluetooth. Concerning the essentially wireless access, however, the internet connection is usually built up via a mobile network between a radio modem and a dial-in node. Such radio modems are in particular integrated in modern mobile phones, in particular in so called smart phones, and mini computers, such as PDAs (PDA: Personal Digital Assistant). If so called UMTS data cards are used (UMTS: Mobile Telecommunications System), in particular internet connections to notebooks via the mobile network can also be established.

### SUMMARY OF THE INVENTION

In many industrialized nations and also in some fast developing countries, the internet is already widely spread and used by many people. Hitherto, wire dependent internet accesses, such as DSL (DSL: Digital Subscriber Line), are generally more used in the private domestic sector than internet accesses via the mobile network, which is inter alia due to the fact that wire dependent internet accesses had a significantly higher band width than internet accesses via the mobile network at least until the introduction of UMTS in the field of mobile radiotelephone.

However, even in many countries which experience an enormous economic development at the moment the internet has not yet spread, at least not area-wide, such that at least a great part of the respective population would have an access to the internet. In these countries it might also often be possible to use the internet for instance via a computer in so called internet cafes, but private accesses to the internet are rather an exception. On the one hand, this is due to the fact that in the concerned countries only few households are connected to a data network which enables an internet access. On the other hand, a major part of the population usually cannot afford to purchase the hardware which is required for this. For the same financial reasons, the possibility to use the internet by means of so called smart phones via a mobile network is also excluded for a major part of the population. Furthermore, a use via smart phones which comprise comparatively small displays for showing graphic representations of internet contents would not be very comfortable and hardly suitable for a utilization of the internet as a joint event within the family or together with friends and acquaintances.

Based upon the above mentioned state of the art, it is the object of the invention to provide a low-cost internet access by means of comparatively few hardware equipment, which internet access shall be usable as area-widely, simply and comfortably as possible. Herein, a device which can be used for providing the internet access advantageously comprises compact dimensions.

For the technical solution of the problem, the present invention proposes a device for providing an internet access for at least one external reproduction device, preferably a television set, and for processing data which have been received via the internet and/or have to be sent via the internet, wherein the processed data are at least partially provided as output signal, in particular as video and/or audio signal at least at one interface of the device for the use by means of the at least one reproduction device, which device is characterized by means for sending and/or receiving electronic data, in particular internet data, via a mobile network, preferably a mobile network according to a GSM, UMTS and/or LTE mobile radiotelephone standard (GSM: Global System for Mobile Communications, UMTS: Universal Mobile Telecommunications System, LTE: Long Term Evolution), means for the electronic processing of data, at least one interface for connecting at least one input device and means for processing control signals which have been received via the interface for connecting at least one input device.

The invention is based upon the knowledge that an as area-widely usable internet access as possible can be realized by the use of a preferably widely established mobile network, in particular in the economically rising countries in which a wire dependent data infrastructure for supplying private households with an internet access is not satisfactorily or at least not area-widely established. Furthermore, the invention is based upon the aspect that an internet access can be realized at lowest costs by including existent resources. In so far the knowledge is used that private households mostly comprise television sets which are provided according to the invention as reproduction devices for the optical and/or acoustic reproduction of internet contents. Furthermore, the invention is based upon the knowledge that differing from the usual use of a computer unit which follows the trend towards a development of more and more performances and a larger spectrum of functions for providing an internet access and for processing data which have been received via the internet and/or have to be sent via the internet, a device according to the invention which is functionally specialized with respect to the use of internet data by an internet user and the graphic reproduction of internet contents on a TV set can be manufactured at low costs.

In such a device according to the invention, the means for establishing an internet connection and the means for processing the internet data which have been received via the mobile network preferably comprise at least one computer unit, at least one control unit, at least one bus unit, at least one memory unit and/or at least one modem. Herein, a modem which is integrated in the device is advantageously designed for at least using GPRS (GPRS: General Packet Radio Service). For a corresponding realization of a device according to the invention with integrated GPRS supporting modem, preferably a chipset of the manufacturer Infineon (Infineon XMM1160 or Infineon XMM2130) or the manufacturer MediaTek (MTK 6225 or MTK 6238) is suitable, in particular since if these or comparable chipsets are used, a cheap fabrication of the device, which also satisfies the required functionality of the device according to the invention, can be realized. But also other suitable chipsets of other manufacturers can be used according to the invention.

In comparison to common devices for providing an internet access, it is in particular renounced according to the invention to equip the device with an own reproduction device for the graphic representation of internet contents. Furthermore, the means for sending and/or receiving electronic data, in particular internet data, via a mobile network, the means for the electronic data processing and the means for processing control signals which have been received via the interface for connecting the at least one input device for providing an internet access for at least one external reproduction device and for processing data which have been received via the internet and/or have to be sent via the internet, are optimized. Herein, other functionalities recede into the background. In particular a use of expensive hardware comprising an extensive spectrum of functions, which is for example used in laptops or netbooks, is not provided.

An especially preferred embodiment of the device according to the invention rather provides that the means for sending and/or receiving electronic data via the mobile network and the means for the electronic data processing advantageously comprise at least one baseband processor. For an improved reception of data via the mobile network an advantageous embodiment of the device according to the invention comprises at least one antenna. In one realization variant the at least one antenna is an external antenna for obtaining a better receiving quality. In a preferred realization variant of the device according to the invention, the at least one antenna is designed as internal antenna for reasons of costs. The at least one internal antenna can be advantageously designed in a different manner as in a mobile phone because of the less limited space conditions in comparison to a mobile phone, whereby an improved reception can be realized in comparison to a mobile phone.

Another realization variant of the device according to the invention which is advantageous in particular with respect to the costs provides that the device only supports the GSM standard and the data services GPRS and E-GPRS (Enhanced GPRS) which can be used by means of the GSM standard. Hereby, no additional antennas for using mobile network standards, such as UMTS and/or other similar mobile network standards are advantageously required.

Since the device according to the invention is preferably provided for a stationary operation, an advantageous embodiment of the device advantageously comprises a connection for an external power supply. A realization variant of the invention furthermore provides at least one backup battery or one backup accumulator. Thanks to the additional use of a battery or an accumulator, an operation without interruptions of the device is advantageously possible also in regions in which a power supply is not permanently assured. Another advantageous realization variant of the device according to the invention provides means for the protection against excess-voltages, whereby, if the device is operated via the electric network, the risk of damaging the device by high fluctuations in the supply network will be advantageously reduced or avoided.

In another advantageous embodiment of the invention, at least one of the interfaces for connecting external appliances is furthermore realized by a serial bus system, preferably USB (USB: Universal Serial Bus) or firewire. Herein, connected appliances are advantageously recognized automatically and can be used directly after the connection of the respective appliance. But also a PS/2 interface can be for instance provided as interface for connecting the input device, in particular for connecting a keyboard and/or a pointing device, such as a computer mouse, as input device, in particular if input devices equipped with such interfaces are more spread or cheaper in the respective distribution country. Another advantageous embodiment of the device according to the invention provides an interface for using memory cards, such as CompactFlash (CF), SD-Memory-Card, Multimedia Card (MMC) and/or similar memory media. For a more exclusive embodiment of the device according to the invention, at least one wireless interface is furthermore provided for connecting external appliances, preferably a Bluetooth and/or infrared interface. If an infrared interface is used, advantageously a remote control which belongs to a television set can also be at least partially used as input device, whereby costs can advantageously be further reduced and an operation of the device can be advantageously further simplified. Another advantageous embodiment of the device according to the invention furthermore comprises at least one interface, preferably a USB interface, for connecting a mass memory medium, such that data which have been received via the internet can be memorized, if necessary, sometimes also permanently.

Another most preferred embodiment of the device according to the invention provides that the means for sending and/or receiving electronic data via the mobile network comprise at least one subscriber identification module (SIM, SIM: Subscriber Identity Module). Herein, the subscriber identification module is preferably an advantageously exchangeable SIM card. Hereby, an especially simple way of billing chargeable internet services by the mobile network provider is advantageously given. A preferred embodiment of the device according to the invention provides the use of so called prepaid cards. An advantageous realization variant comprises a function key for fetching a remaining credit, which can be numerically and/or graphically represented on the connected reproduction device upon fetch. Herein, the function key is preferably a so called soft key and can be selected on the external reproduction device via a control menu by means of an input device which is connected to the device according to the invention. For receiving a subscriber identification module, preferably a SIM card, a realization variant of the device according to the invention advantageously comprises a plug-in unit which is advantageously accessible from outside. Another realization variant of the device according to the invention furthermore comprises a so called SIM lock functionality, whereby the device can only be operated with the SIM card of a certain mobile network provider.

In another realization variant of the device according to the invention, the device is advantageously designed to realize a measurement with respect to the signal receiving intensity and/or the signal quality only upon each switching-on operation of the device and/or by corresponding request of the user within the scope of logging in a mobile network and/or for selecting an appropriate radio cell. Hereby, measurements which have to be carried out permanently, such as measurements of the signal intensity and the signal quality of the actual radio cell, and program routines associated therewith, which are in particular obligatory with a mobile phone for a so called handover, can be omitted.

In another advantageous embodiment of the invention the device is designed to support a transmission of internet data by means of GPRS (GPRS: General Packet Radio Service), EDGE (EDGE: Enhanced Data Rates for GSM Evolution), UMTS (UMTS: Universal Mobile Telecommunications System), CDMA2000 (CDMA: Code Division Multiple Access) and/or HSDPA (HSDPA: High Speed Downlink Packet Access). Thanks to the use of such transmission standards, comparatively high data transmission rates can be advantageously realized whereby the utilization experience during the use of internet contents will be advantageously improved.

A most preferred embodiment of the device according to the invention is characterized by an operating system, preferably a real-time operating system (RTOS, RTOS: real-time operating system), in particular for the administration of the hardware of the device and/or for the control of the data processing. A real-time operating system, such as for instance Nucleus can be advantageously adapted to less complex cheap hardware in an optimal manner and makes advantageously low demands on the used hardware and can be designed in an especially resource saving manner. However, in a more exclusive realization variant of the invention, which is equipped with more complex hardware, the use of operating systems, such as Android, Windows CE or Symbian is also imaginable, whereby a more extensive application spectrum of the device according to the invention can be realized. In another preferred embodiment, the device comprises a Java virtual machine (JVM). Hereby, so called applets can be advantageously used with the device. A JVM in particular enables the use of a Java based browser, such as Opera Mini, for representing internet contents by means of the device according to the invention. Another embodiment provides the use of a so called Dalvik Virtual Machine which is a component of the Android OS, whereby the so called Android Browser can be advantageously used with the device according to the invention.

Another preferred realization variant provides that the device comprises an integrated browser, in particular a MIDP compatible browser (MIDP: Mobile Information Device Profile), such as Opera Mini. The browser advantageously supports the Wireless Application Protocol (WAP), whereby internet contents can be advantageously represented more rapidly, also if the transmission rate is slower and the reply times of a used mobile network are longer. The browser used with the device advantageously compresses the data traffic, whereby other speed advantages are achieved in the transmission of data as well as in the representation of internet contents. The browser advantageously supports a so called pre-rendering which is carried out on a server, whereby the demand of resources by the device advantageously remains small. Thanks to these features of the browser, the utilization experience is advantageously further improved for users of internet contents. Furthermore, thanks to the use of the WAP, the internet contents can be better adapted to a relatively low resolution. This is especially advantageous, since more costs can be reduced by providing an output signal with comparatively low resolution. For further improving the utilization experience of users of internet contents, another embodiment of the present invention provides a so called buffering of internet contents for a representation and/or reproduction of internet contents which is poorer in delays respectively free of delays, in particular when audio and/or video sequences are played. In a preferred realization variant of the device, the device uses a method for the transmission of data in mobile networks from at least one database providing data which are provided for transmission to a terminal which can be operated in a mobile network, wherein the terminal is holding data ready which correspond to at least a part of data which are held ready by the database, a link to data of the database is displayed, and if the displayed link is selected, correspondingly linked data will be received via the mobile network, and if the displayed link is selected, data corresponding to the link will be reproduced, wherein upon selection of the displayed link an inquiry for data corresponding to the link will be addressed to the terminal and the database, and if data according to the link are present, the terminal will in the first instance reproduce at least the one part of data which corresponds to the data which are held ready by the database and afterwards the data corresponding to the link, which have been received via the mobile network, will be reproduced in a synchronized manner with the data corresponding to the link, which are held ready by the terminal.

Another advantageous embodiment of the device according to the invention is characterized by S-video, Composite, Component, RGB and/or VGA as interface for connecting at least one external reproduction device, wherein S-video and/or RGB are especially preferred, since S-video and RGB are comparatively highly spread. Furthermore, S-video as well as RGB offer a relatively good reproduction quality in a comparatively cheap manner. Herein, a reproduction device can be connected to the interface of the device according to the invention in particular by means of cinch connectors, Scart and/or VHF respectively UHF connectors or similar suitable connections. Although it is generally less advantageous for reasons of costs, a realization variant with at least one interface according to a digital standard, such as DVI (Digital Visual Interface) or HDMI (High Definition Multimedia Interface), can also be realized.

A realization variant of the device according to the invention comprises at least one encoder which is designed to provide the output signal corresponding to a reproduction format supported by the at least one reproduction device at the at least one interface for connecting the at least one reproduction device. An advantageous embodiment of the invention provides that after the encoding a so called upscaling (high scaling) will be realized. Herein, the original resolution is extrapolated to a higher resolution and missing picture elements are interpolated. Herein, the device advantageously supports methods for colour transmission in television, in particular according to PAL (PAL: Phase Alternating Line) and/or NTSC (NTSC: National Television Systems Committee). Advantageously, the output signal provided by the device according to the invention supports a resolution which is typical for television sets (768×576 picture elements for PAL, 720×480 picture elements for NTSC). Furthermore, it is provided that in another advantageous realization variant, the output signal provided by the device according to the invention also provides resolutions according to the spread VGA and/or XGA standards, in particular QVGA (320×240), HVGA (480×320), VGA (640×480), SVGA (800×600) and/or WVGA (854×480), wherein the resolutions can at least slightly differ from the above mentioned values. A higher resolution generally improves the utilization experience, but most often entails higher costs. In so far a resolution in HGVA (480×320) is considered as suitable cheap solution.

In another realization variant of the invention, an external video chip, for instance made by DisplayLink, is connected to a USB interface of the device, which video chip prepares the output signal for being output on an external reproduction device. In a preferred embodiment of this realization variant, all image information will be supplied to the video chip connected via USB, for example a suitable DisplayLink chip, which is then responsible for the encoding and the reproduction on the reproduction device, preferably a television set. The realization is preferably carried out via a cable which includes the video chip and comprises a USB connector on the one side and a connection, such as an S-video connector, which is suitable for the reproduction device on the other side.

In another especially advantageous realization variant of the device according to the invention, the device is designed like a set-top box which can be preferably placed on or at least next to the external reproduction device. Herein, the device according to the invention preferably comprises a substantially closed housing, wherein the interfaces, in particular the at least one interface for connecting at least one input device and the at least one interface for connecting at least one reproduction device, are accessible from outside.

Furthermore, the device according to the invention advantageously comprises at least one operating element, preferably in form of a toggle switch, tumbler switch or latch switch, by means of which the device can be brought into the operating state. Furthermore, the device preferably comprises at least one signalization element, preferably in form of a LED (LED: Light Emitting Diode) which signalizes the operating state of the device and in particular informs the user whether the device is online, i.e. whether chargeable internet services are being used. In this manner it can be advantageously avoided that in particular if the use of internet services is billed on a time base, costs are produced in a quasi unnoticed manner, when the device according to the invention is not used. Another advantageous embodiment of the invention furthermore provides that the device advantageously does not send and/or receive any internet data via the mobile network, if no input devices and/or no reproduction device are connected and/or the reproduction device is not in the operating state. This functionality can be advantageously deactivated by the user, in particular before realizing extensive downloads which shall for instance be executed over night.

Another realization variant of the device according to the invention is designed for establishing a telecommunication connection. Herein, the telecommunication connection is advantageously established via a mobile network. Preferably the device according to the invention is furthermore designed to provide an input menu which can be operated by the user for a representation by means of the external reproduction device. Via this input menu the user can advantageously select the desired function of the device respectively the desired service which is offered for use by the device, in particular internet services and/or telecommunication functions of the device, using the at least one input device connected to the device. In another realization variant the device according to the invention comprises a microphone which is preferably integrated in the device and can be used for telecommunication purposes. The audio output, in particular the voice output, is advantageously realized via the at least one external reproduction device, preferably a television set. Furthermore, a realization variant is provided in which the voice output is realized via a loudspeaker which is integrated in the device according to the invention, for instance a simple so called hands-free speaker.

Another advantageous embodiment of the device furthermore comprises at least one interface for connecting a device for recording spoken language, which can be in particular used for telecommunication purposes. The interface is preferably a jack bush. A head set can be preferably connected to the interface, whereby the comfort of the telecommunication will be advantageously increased. In an exclusive realization variant of the device according to the invention it is furthermore provided that the device comprises a telephone receiver. Herein, both a realization variant in which the telephone receiver is connected to the device via a cable and a cordless realization variant, preferably according to the DECT standard (DECT: Digital Enhanced Cordless Telecommunications) is provided. The call number is advantageously input using at least one connected input device, wherein in the realization variant of the device which comprises a telephone receiver, the telephone receiver preferably also provides an input device, preferably in form of a keypad embedded in the telephone receiver. In another embodiment of a more exclusive variant of the device according to the invention, this one is designed for supporting a visual telephony, wherein the received video signal of at least one communication partner can be represented on the at least one reproduction device.

In another advantageous embodiment of the device according to the invention, the device comprises a so called telephone book functionality, wherein a program application provided by the device in particular supports the input, memorization and calling of contact information of other persons.

Another realization variant of the device according to the invention is characterized by at least one interface for connecting a so called landline network telephone, wherein the device preferably comprises means for the signal conversion, preferably such that a telecommunication connection can be established via the mobile network by means of the landline network telephone.

Another advantageous embodiment of the device according to the invention is designed for the use of at least one message service of the mobile network, preferably SMS (SMS: Short Message Service) and/or MMS (MMS: Multimedia Messaging Service). Herein, a program application provided by the device advantageously supports the writing of text messages for being sent by means of a message service of the mobile network. The input of text is preferably realized by using an input device which is connected to the device.

In another advantageous embodiment of the device, the means for sending and/or receiving electronic data and/or the means for the electronic data processing are at least partially provided by a mobile terminal which can be operated in the mobile network, preferably a mobile telephone or a data stick, wherein the mobile terminal can be connected to the device according to the invention by means of an interface. Hereby, other existent resources can be advantageously used for providing an internet access for at least one external reproduction device and costs can be thus further reduced, since such a realization variant of the device according to the invention can manage without own baseband processor. As realization variants both a wire dependent interface and a radio interface, preferably a Bluetooth interface, are provided. The keyboard of the mobile terminal can be advantageously used as input device for the use with the device according to the invention, whereby costs are further reduced. An alternatively provided data or surf stick can be advantageously connected to the device via a USB interface. Furthermore, the use of a UMTS data card is provided in another embodiment of the invention.

A preferred realization variant provides that the device according to the invention is designed for receiving the mobile terminal like a charging station of the mobile terminal.

Another advantageous embodiment of the invention provides that the device is designed like an input device, wherein the input device preferably comprises at least one keyboard. Hereby, advantageously only the external reproduction device has to be connected to the device, whereby advantageously less connection cables are required and no space for additional input devices is required. Furthermore, the input device preferably comprises a pointing device, preferably a touchpad, a track ball and/or a tumbler switch of the type of a joy stick. A tumbler switch which can be moved into four directions will be advantageously supported by Opera Mini as Java based browser. The input device can be advantageously used in a more flexible manner thanks to the integration of a pointing device in the input device. In particular, no laying-on surface, for instance for the operation of a computer mouse is required. Instead, the device according to the invention of the type of an input device can be comfortably operated, for example from the user's lap.

### BRIEF DESCRIPTION OF THE DRAWINGS

Other details, characteristics and advantages of the invention will be explained in more detail, in the following by means of the exemplary embodiments represented in the figures of the drawing. Herein:

FIG. 1 is a perspective representation of an exemplary embodiment of a device according to the invention,

FIG. 2 is a block diagram for the schematic representation of components of an exemplary embodiment of a device according to the invention,

FIG. 3 is a block diagram for the schematic representation of components of another exemplary embodiment of a device according to the invention,

FIG. 4 is a block diagram for the schematic representation of components of another exemplary embodiment of a device according to the invention,

FIG. 5 is a schematic diagram of an exemplary embodiment of an initiation of a device according to the invention,

FIG. 6 is a schematic diagram of an exemplary embodiment of a device according to the invention in the state of use,

FIG. 7 is a schematic diagram of an exemplary embodiment of a device according to the invention comprising a telephone function and a connected telephone receiver,

FIG. 8 is a schematic diagram of another exemplary embodiment of a device according to the invention,

FIG. 9 is a perspective representation of another exemplary embodiment of a device according to the invention,

FIG. 10a-FIG. 10F are respectively a schematic diagram of another exemplary embodiment of a device according to the invention in the state of use and

FIG. 11 is a schematic diagram of a method according to the invention for providing an internet access for at least one external reproduction device and for processing data which have been received via the internet and/or have to be sent via the internet by means of a device according to the invention.

### DETAILED DESCRIPTION OF THE INVENTION

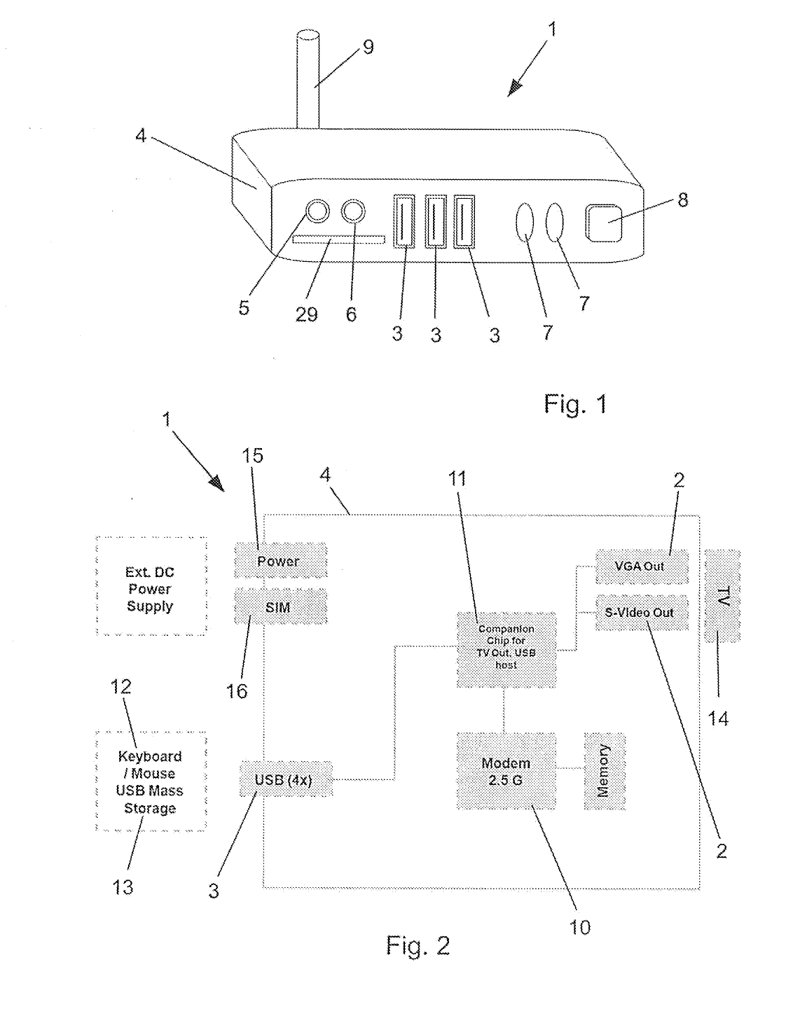

An exemplary embodiment of a device 1 according to the invention providing an internet access for at least one external reproduction device, preferably a television set, and for processing data which have been received via the internet and/or have to be sent via the internet, is represented in FIG. 1. In the device 1, the processed data are at least partially provided as output signal, in particular as video and/or audio signal on at least one interface 2 of the device 1 (the interface 2 is not explicitly represented in FIG. 1) for the use by means of the at least one reproduction device. The device 1 comprises means for sending and/or receiving electronic data, in particular internet data, via a mobile network, preferably a mobile network according to a GSM, UMTS and/or LTE mobile radiotelephone standard, means for the electronic data processing, at least one interface 3 for connecting at least one input device as well as means for processing control signals which have been received via the interface 3 for connecting the at least one input device.

The device 1 is designed like a set-top box and comprises an essentially closed housing 4, wherein the interfaces, in particular the at least one interface 2 for connecting at least one input device and the at least one interface 3 for connecting at least one reproduction device are accessible from outside. As interface 2 for connecting an external reproduction device, in the present case preferably a television set, the device 1 comprises a so called mini DIN-S-video bush which is embedded in the rear side of the device 1 and via which in the present case a video signal having a resolution of 800×600 picture elements is provided. A resolution of 800×600 picture elements can be advantageously realized with small quality losses in particular with a television set as reproduction device, since the resolution is close to the PAL resolution. However, for reasons of costs an HVGA resolution should be preferred with respect to a resolution of 800×600 picture elements.

Furthermore, the device 1 comprises three USB connections 3 on the front side, wherein at least one USB connection is provided for connecting a mass storage medium and at least one USB connection is provided as interface 3 for connecting at least one input device. In case of need also another input device can be connected via the USB connection instead of a mass storage medium. The device 1 furthermore comprises an interface for the connection of a memory card, in the present case an SD memory card which can be inserted into the card shaft 29 for connection to the interface. The device 1 furthermore comprises an interface 5 on the front side for connecting an audio input device, preferably a microphone, and an interface 6 for connecting an audio output device, preferably a head set, wherein the two interfaces 5, 6 are respectively designed as 3.5 mm jack bush.

The device 1 is advantageously designed for establishing a telecommunication connection, wherein a user of the communication can for instance use a headset which is connected via the jack bushes 5 and 6. Herein, the telecommunication connection can be established directly via the mobile network or by means of voice-over-IP depending on the predeterminations of the user. Two LEDs which are embedded in the front of the device 1 advantageously inform the user about the respective operating state of the device 1. The device 1 can be switched on respectively out via an operating element 8 which is designed as latch switch. On the rear side, the device 1 comprises an external antenna 9, which can at least be partially arranged in a movable manner, wherein the antenna 9 is advantageously designed for sending and/or receiving data in different frequency bands, in the present case in particular 900 MHz and/or 1800 MHz.

FIG. 2 shows an exemplary embodiment of the device according to the invention 1 in form of a block diagram. Herein, the continuous line referenced by the reference numeral 4 represents the housing of the device 1. The means for sending and/or receiving electronic data, in particular internet data, comprise a radiotelephone modem 10 which is designed to support the data service GPRS as well as techniques for increasing the data rates in mobile networks, such as EDGE (EDGE: Enhanced Data Rates for GSM Evolution). In the present case, the means for the electronic data processing comprise at least one chip 11 which administrates or operates the interfaces 3 for connecting at least one input device 12 and the interfaces 2 for connecting at least one external reproduction device 14.

The exemplary embodiment in FIG. 2 comprises two interfaces 2 for connecting an external reproduction device 14, wherein one interface 2 is designed as VGA connection bush and the other interface 2 is designed as S-video bush. A television set can be for instance connected as reproduction device 14 via the S-video bush. A computer monitor can be for instance alternatively and/or additionally connected via the VGA connection bush. In the present case, the interfaces 3 for connecting at least one input device 12 are respectively designed as USB connections. In the exemplary embodiment the device comprises four of these ones. In case of need, a USB mass storage medium 13 can also be in particular connected via at least one of the USB connections.

For power supply, the device 1 comprises a connection 15 for connecting a mains apparatus. Furthermore, the device 1 comprises an interface 16 which is accessible from outside for receiving a subscriber identification module, in the present case an exchangeable SIM card. In an embodiment which is not represented here, the subscriber identification module can also be directly integrated in the device 1.

Another exemplary embodiment of a device according to the invention 1 is represented as block diagram in FIG. 3. The device 1 preferably comprises a chipset IFX2130 or a chipset XMM6238 or a chipset which is comparable with respect to the functionality as means for sending and/or receiving electronic data, in particular internet data via a mobile network.

Furthermore, apart from other possible chipsets, in particular a chipset MTK 6225 of the manufacturer MediaTek or a chipset XMM 1160 of the manufacturer Infineon would be in particular imaginable. The USB interfaces 3, via which an input device 12 and/or a USB mass storage medium can be connected, are controlled by a USB controller 17. The preparation of the internet data which have to be represented by means of the external reproduction device 14 is in particular realized by a graphic controller 18 and a video encoder 19. Preferably a Nexia 21168, a Fairchild FMS3818 or a TI THS8200 can be used as video encoder 19. But also other suitable encoders of other manufacturers or of another type can be furthermore used for the use in the device according to the invention. The output signals can be callipered as S-video, composite and/or component signal via correspondingly designed interfaces 2.

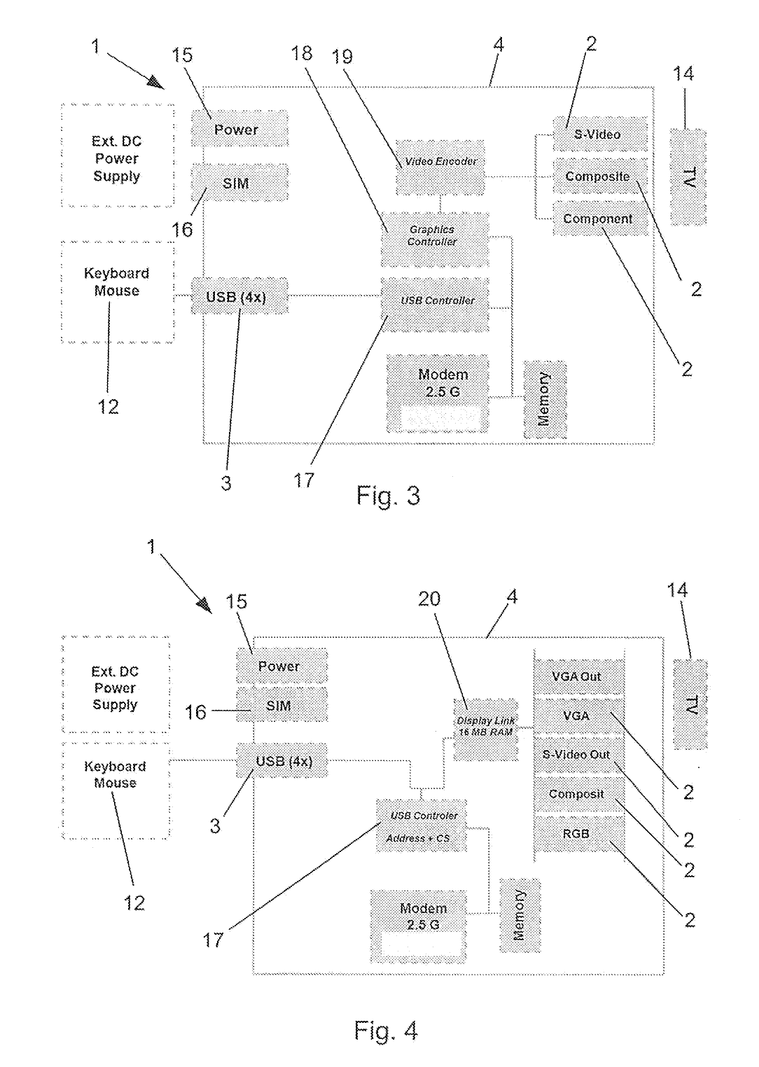

FIG. 4 shows another exemplary embodiment of a device according to the invention 1 in a representation as block diagram. Herein, a chipset from MediaTek serves as means for sending and/or receiving electronic data, in particular internet data. A video chip 20, in the present case a video chip from DisplayLink, which is connected to the USB bus, serves for preparing the internet data which have to be represented by means of the external reproduction device 14. The video chip 20 in particular provides output signals according to the VGA, S-video, Composite and RGB standard at correspondingly designed interfaces 2. Herein it is not required that all interfaces are provided. In particular for reasons of costs, it can be renounced to a second VGA connector.

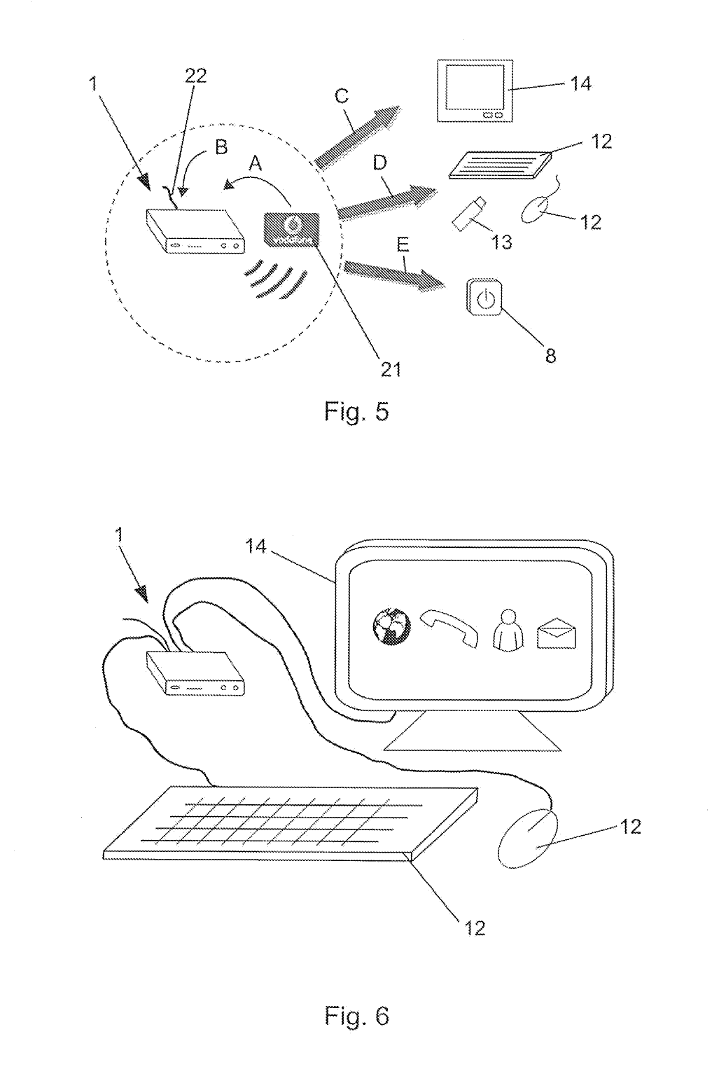

In FIG. 5, the initiation of a device according to the invention 1 is schematically represented. For initiating the device 1, a subscriber identification module 21, in the present case a SIM card, is inserted into the device 1 in a step A. In a step B, the device 1 is connected to a current cable 22 via the connection 15 for an external power supply. In a step C, an external reproduction device 14, in the present case a television set, is connected to the device 1 via an interface 2 for connecting an external reproduction device 14 (not explicitly represented in FIG. 5). In another step D, the desired input devices 12, in the present case a computer keyboard and a computer mouse, as well as a mass storage medium 13, in the present case a USB stick, are connected to the device 1. In a step E, the device is initiated via an operating element 8 which is designed as touch contact, by operating the operating element 8.

After having operated the operating element 8, the operating system of the device 1, in the present case the real time operating system Nucleus, starts. Thereupon, a selection menu will be represented by means of the switched on external reproduction device 14, wherein the user can select the desired function to be used via the selection menu by means of the input device 12 connected to the device 1. Herein, in particular internet services, such as e-mail, instant messaging or the World Wide Web, telephone functions, such as establishing a telecommunication connection or calling a general view of telephone calls which have been received in absence and/or similar service functions connected to a telephone function, or message services which can be used via the mobile network, such as SMS or MMS can be selected as functions of the device 1.

The device 1 is advantageously designed for a transmission of internet data by means of a wide band transmission technique in the mobile network, such as UMTS (UMTS: Universal Mobile Telecommunications System), CDMA2000 (CDMA: Code Division Multiple Access) and/or HSDPA (HSDPA: High Speed Downlink Packet Access).

FIG. 6 is a schematic diagram which shows an exemplary embodiment of a device according to the invention 1 in the state of use. A computer monitor is connected as reproduction device 14 to the device 1 via an interface 2 for connecting an external reproduction device, which is in the present case designed as a VGA bush, wherein the data which have been processed by the device 1 will be at least partially provided at the VGA bush 2 of the device 1 as video signal for the use by means of the computer monitor 14. A computer keyboard is connected as input device 12 via an interface 3 for connecting at least one input device, which is in the present case designed as PS/2 interface. A computer mouse is connected as other input device 12 via another interface 3 for connecting at least one input device, which is designed as USB interface.

In the exemplary embodiment the device 1 comprises an integrated Java-based browser which inter alia supports the Wireless Application Protocol (WAP). When the Wireless Application Protocol is used, internet contents will be advantageously reduced with respect to the amount of data to be transmitted, such that also with slower transmission rates of the mobile network a fast access to internet contents is possible. The functions of the browser can be operated by means of the connected input devices 12. For the further subjective increase of the transmission speed of internet contents, in particular for playing audio and/or video sequences, the device preferably comprises means for the so called buffering of internet contents, wherein before the internet contents are reproduced at least a part of the contents to be reproduced will be advantageously for the time being memorized in a memory for a retarded reproduction. Hereby, the reproduction of internet contents is at least subjectively perceived as less delayed or free of delays.

If the device 1 is not used for a certain time, i.e. the device 1 does not receive any control signals from at least one of the input devices 12 and no data are sent and/or received via the mobile network in particular within the scope of a download or upload, it is provided that the device 1 automatically interrupts a standing internet connection. In this way, advantageously no costs are charged to the user for a not actively used internet connection. The time period after which the device 1 will terminate the internet connection, if this one is not used, can be advantageously predetermined by the mobile network provider and/or the user.

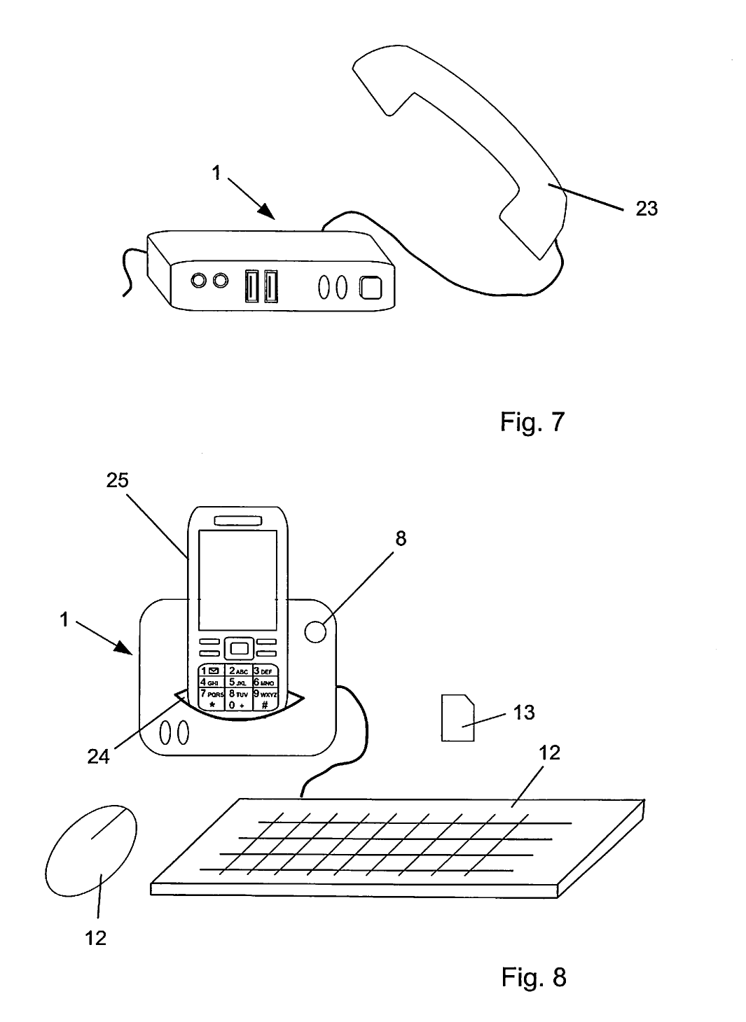

FIG. 7 shows an exemplary embodiment of a device according to the invention 1 comprising a telephone function. Herein, the device 1 is designed to establish a telecommunication connection both directly via the mobile network and via voice-over IP. A telephone receiver 23 is connected to the device 1 for making phone calls. The device 1 and/or the telephone receiver 23 advantageously have a keypad via which a call number can be entered (not represented in the figure). In a realization variant of the device 1, the call number can also be entered, in case of need, via an external input device, in particular a computer keyboard. Advantageously, the device 1 additionally comprises at least one operating element by the operation of which an incoming phone call can be accepted and/or terminated (not represented in FIG. 7). Herein, incoming phone calls are advantageously optically and/or acoustically signalized via an info LED which is integrated in the device 1 and/or via at least one external reproduction device. In another realization variant of the device, the device comprises an integrated audio output device, preferably a loudspeaker. In this realization variant, incoming phone calls can at least additionally be signalized in an acoustic manner via this audio output device.

In FIG. 8 another exemplary embodiment of a device according to the invention 1 is outlined. Herein, the device 1 is designed like a charging station. The device 1 comprises a receiving element 24 for at least partially receiving a mobile terminal in the device 1, which receiving element is in the present case designed as insertion shaft having contact pins (not explicitly represented in FIG. 8), in which a mobile terminal 25 can be arranged such that the mobile terminal 25 is electrically connected to the device 1. Herein, the receiving element 24 serves as interface between the device 1 and the mobile terminal 25. The mobile terminal 25 is equipped like a cordless telephone and in particular comprises a numeral keyboard. The mobile terminal 25 can be used like a classic DECT telephone (DECT: Digital Enhanced Cordless Telecommunication), wherein the telecommunication function is based upon the GSM standard in the present case. For the power supply, the mobile terminal 25 comprises accumulators which are electrically charged if the mobile terminal 25 is placed in the device 1.

In a realization variant, the mobile terminal 25 is a mobile phone having means for sending and/or receiving electronic data, in particular internet data, via a mobile network, preferably a mobile network according to a GSM, UMTS and/or LTE mobile radiotelephone standard, and means for the electronic data processing. The device 1 is advantageously designed to use the means for sending and/or receiving electronic data, in particular internet data, via the mobile network and/or the means for the electronic data processing of the mobile terminal 25 via the receiving element 24 which is designed as interface for at least partially providing an internet access for at least one external reproduction device, preferably a television set, and for processing data which have been received via the internet and/or have to be sent via the internet.

In this realization variant, the device 1 is advantageously equipped with less hardware and can thus be offered cheaper. But in this realization variant, the device 1 at least comprises an interface for the connection to the mobile terminal 25 as well as means for preparing the internet data which shall be represented by means of an external reproduction device and means for providing the prepared data as output signal, in particular as video and/or audio signal on at least one interface of the device 1 for the use by means of the at least one reproduction device. In another realization variant, the interface for connecting the device 1 to the mobile terminal 25 is designed as wireless interface, in particular as Bluetooth or infrared interface.

As previously described in the exemplary embodiments, input devices 12, such as computer keyboards and/or pointing devices and/or USB mass storage media 13 can be connected to the device 1 via corresponding interfaces also in the exemplary embodiment in FIG. 8.

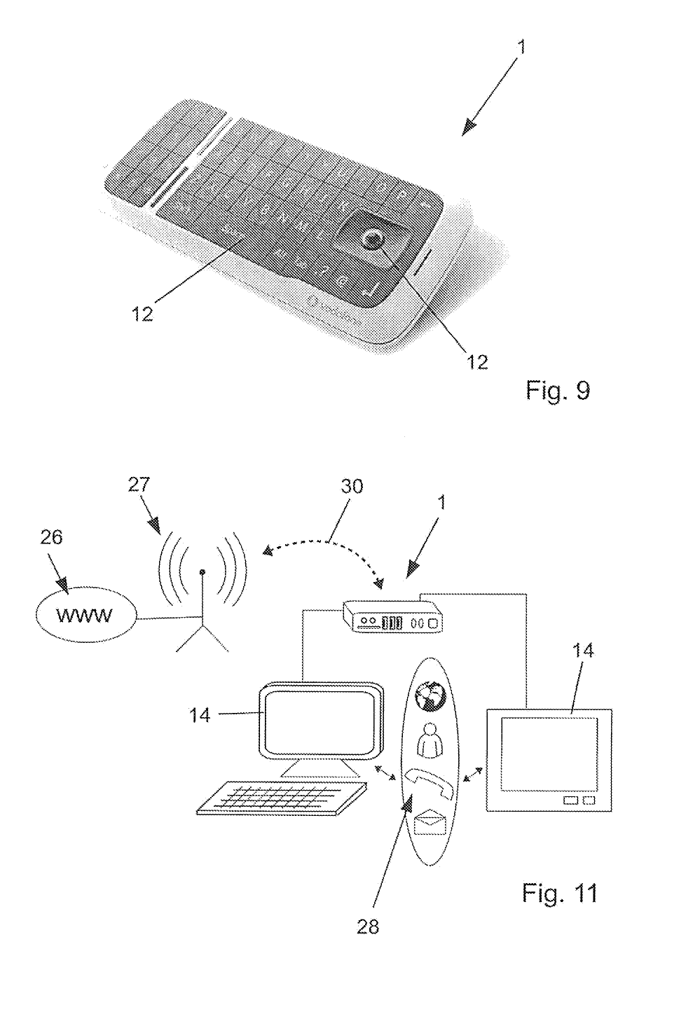

FIG. 9 is a schematic diagram which shows another exemplary embodiment of a device according to the invention 1. Herein, the device 1 is designed like an input device 12. Herein, the input device 12 in particular comprises numeral keys, letter keys and/or function keys, in particular function keys which are known from a computer keyboard. Furthermore, the input device 12 comprises a so called track ball. Instead of a track ball, the device 1 according to the invention can also be equipped with a mini joystick, a 4-way rocker key which is movable in four directions or a comparable operating element. A so called mouse pointer can be advantageously controlled by means of such an operating element. A 4-way rocker key is advantageously supported by Opera Mini as Java-based browser which is preferably integrated in the device 1. The device 1 advantageously comprises at least one interface 3 via which, in case of need, additional input devices, such as a computer mouse can be connected (the interfaces 3 are not explicitly represented, neither the other interfaces, in particular the interface for connecting an external reproduction device).

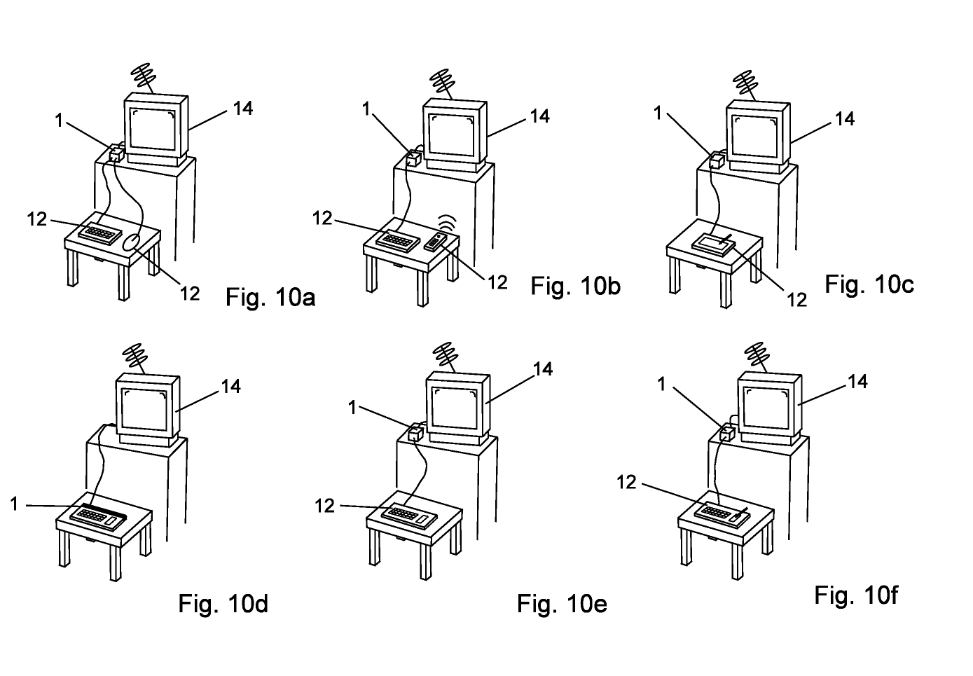

FIGS. 10a through 10f are schematic diagrams in which other exemplary embodiments of the device according to the invention are represented in the state of use. Herein, different input devices 12 are connected to the device 1, in particular different pointing devices for controlling a graphic user interface which is provided by the device 1 and represented on the external reproduction device 14. In the present case, the external reproduction device 14 is a tube television set which is connected to the device 1 via a composite interface by means of a UHF plug-in connection.

In FIG. 10a, a computer keyboard and a computer mouse are connected as input devices 12 via a USB cable to a USB interface of the device according to the invention 1.

In FIG. 10b, an infrared remote control can be used as other input device 12 with the device according to the invention 1, apart from a computer keyboard. For this, the device 1 comprises an infrared interface as other interface 2 for connecting at least one input device (the interface 2 is not explicitly represented in FIG. 10b).

In FIG. 10c, a so called graphics tablet is connected as input device 12 to the device 1. Inputs can be made as well as the graphic interface can be operated by means of a pencil-like element.

In FIG. 10d, the device according to the invention 1 is designed like an input device 12. The device 1 provides the data to be represented by means of the external reproduction device 14 as video signal at a mini Din-S video bush. The device 1 is connected to a television set as external reproduction device 14 by means of a corresponding S-video cable. The device 1 comprises a keyboard which is essentially a copy of a computer keyboard. Furthermore, the device comprises a so called touch pad which the user can operate with the finger tip. Instead of the touch pad, in particular a track ball, a so called 4-way rocker key as well as an optical navigation sensor is also provided as operating element. The device 1 furthermore comprises at least one interface 5 for connecting a device for recording spoken language, which can be in particular used for telecommunication purposes. Furthermore, the device 1 has another interface 6 via which an audio signal can be output. The interfaces 5 and 6, which are in the present case designed as 3.5 mm jack bushes can be for instance connected to a head set which can be used for telecommunication purposes.

In another realization variant of the invention, a voice controlled operation of the device 1 is also provided which is realized via an audio input device. The audio input device is preferably a microphone which is integrated in the device or can be connected to the device and via which the voice orders are entered.

The means for sending and/or receiving electronic data of the device 1 inter alia comprise a subscriber identification module, in the present case a SIM card which is designed as a so called prepaid card. It is provided that the device 1 comprises a so called credit key (not represented in FIG. 10d) via which a rest credit which remains on the prepaid card can be called. The rest credit will be preferably displayed on the external reproduction device 14 after operating the credit key.

In FIG. 10e, an input device 12 is connected to the device according to the invention 1 via a USB interface, wherein the input device 12 both comprises a keypad and a so called touch pad.

In FIG. 10f a graphics tablet is embedded, besides a keypad, in the input device connected to the device 1, which graphics tablet can be operated by means of a pencil-like input means. The advantages of input devices 12 in which a pointing device for controlling user interfaces is integrated, are in particular that also in countries in which due to cultural reasons sitting furniture and/or tables are less spread and thus pointing devices like a computer mouse can in so far not so easily operated, a comfortable operating option will be provided for the user.

In FIG. 11 a method for providing an internet access for at least one external reproduction device 14, preferably a television set, and for processing data which have been received via the internet 26 and/or have to be sent via the internet 26 is represented, wherein the processed data 28 are at least partially provided as output signal, in particular as video and/or audio signal on at least one interface of the device 1 for the use by means of the at least one reproduction device 14, the internet access is provided via a mobile network 27, preferably a mobile network according to a GSM, UMTS and/or LTE mobile radiotelephone standard and the processing of data, in particular data which have been received via the internet 26 and/or have to be sent via the internet 26 will be realized by means of a device 1 according to the invention as described above.

In the method a device 1 according to the invention sends and/or receives (symbolically represented by the arrow 30) data which have been received or sent via the internet 26 via the mobile network 27. These data are processed using the device 1 and prepared such that data 28 to be represented by means of an external reproduction device 14, in the present case a computer monitor and/or a television set, are provided as output signal which can be used by means of the external reproduction device 14. The device 1 is operated by means of an input device 12 which can be connected to the device 1, wherein in particular internet services, such as e-mail and/or internet messaging can be used by means of the device 1 and surfing in the internet 26 is enabled.

The exemplary embodiments of the invention represented in the figures of the drawing and described in connection with these ones only serve for explanation of the invention and are not limiting for this one.

1. A device for providing an internet access for at least one external reproduction device and for processing data which have been received via the internet and/or have to be sent via the internet,
wherein the processed data are at least partially provided as an output signal, in particular as a video and/or audio signal at least at one interface of the device for the use by means of the at least one reproduction device, characterized by
means for sending and/or receiving electronic data, in particular internet data, via a mobile network,
means for the electronic processing of data,
at least one interface for connecting at least one input device and means for processing control signals which have been received via the interface for connecting at least one input device.

2. The device according to claim 1, characterized in that the means for sending and/or receiving electronic data via the mobile network and the means for the electronic data processing at least comprise one baseband processor.

3. The device according to claim 1, characterized in that the means for sending and/or receiving electronic data via the mobile network comprise at least one subscriber identification module.

4. The device according to claim 1, characterized in that the device is designed to support a transmission of internet data by means of GPRS (General Packet Radio Service), EDGE (Enhanced Data Rates for GSM Evolution), UMTS (Universal Mobile Telecommunications System), CDMA2000 (Code Division Multiple Access) and/or HSDPA (High Speed Downlink Packet Access).

5. The device according to claim 1, characterized by an operating system for the administration of the hardware of the device and/or for the control of the data processing.

6. The device according to claim 1, characterized by an integrated browser.

7. The device according to claim 1, characterized by S-video, composite, component, RGB and/or VGA as the interface for connecting at least one external reproduction device.

8. The device according to claim 1, characterized by at least one encoder which is designed to provide the output signal corresponding to a reproduction format supported by the at least one reproduction device at the at least one interface for connecting the at least one reproduction device.

9. The device according to claim 1, characterized in that the device is designed to be a set-top box.

10. The device according to claim 1, characterized in that the device is designed for establishing a telecommunication connection.

11. The device according to claim 1, characterized by at least one interface for connecting a device for recording spoken language.

12. The device according to claim 10, characterized by at least one interface for connecting a landline network telephone, wherein the device comprises means for signal conversion such that a telecommunication connection can be established via the mobile network by means of the landline network telephone.

13. The device according to claim 1, characterized in that the device is designed for the use of at least one message service of the mobile network.

14. The device according to claim 1, characterized in that the means for sending and/or receiving electronic data and/or the means for the electronic data processing are at least partially provided by a mobile terminal operable in the mobile network, wherein the mobile terminal can be connected to the device by means of an interface.

15. The device according to claim 14, characterized in that the device is designed for receiving the mobile terminal like a charging station of the mobile terminal.

16. The device according to claim 1, characterized in that the device comprises a keyboard.

17. A method for providing an internet access for at least one external reproduction device and for processing data which have been received via the internet and/or have to be sent via the internet,
providing the processed data at least partially as an output signal, in particular as video and/or audio signal on at least one interface of a device for the use by means of the at least one reproduction device,
providing the internet access is provided-via a mobile network,
and processing data received via the internet and/or to be sent via the internet be means of the device.

18. The device according to claim 1, wherein the mobile network utilizes a GSM, UMTS and/or LTE mobile radiotelephone standard,
